(19) United States
(12) Patent Application Publication
(10) Pub. No.: US 2002/0005318 A1
(43) Pub. Date: Jan. 17, 2002

(54) Valve in an exhaust gas muffler device of a motor vehicle

(76) Inventors: Herbert Schumacher, Lichtenwald (DE); Volker Geis, Waiblingen (DE)

Correspondence Address: M. Robert Kestenbaum, 11011 Bermuda Dunes NE, Albuquerque, NM, 87111, US

(21) Appl. No.: 09/906,492

(22) Filed: Jul. 16, 2001

(30) Foreign Application Priority Data
Jul. 15, 2000 (DE) 100 34 557.3

(51) Int. Cl. F01N 1/00; F16K 17/00

(52) U.S. Cl. 181/237; 181/228

(57) ABSTRACT

A valve in an exhaust gas muffler device of a motor vehicle with exhaust gas conducting openings connecting the interior of a housing of the muffler device to outward of this housing in which one of the housing openings can be closed with a closure element situated within the housing and displaceably mounted on the housing. When the opening is closed, the closure element sealingly abuts on the edge of the opening. The displacement axis of the closure element runs perpendicularly with respect to the plane of the housing opening, and the closure element is coupled to a positioning motor.

### CROSS-REFERENCES TO RELATED APPLICATION

Not applicable.

### STATEMENT REGARDING FEDERALLY SPONSORED RESEARCH OR DEVELOPMENT

Not applicable.

### BACKGROUND OF THE INVENTION

The invention relates to a valve in an exhaust gas muffler device of a motor vehicle with housing opening conducting exhaust gas and connecting the interior of a housing of the muffler device to outward of said housing.

### TECHNICAL FIELD

Known exhaust gas mufflers partially comprise muffler housings with at least two exhaust gas discharge openings, one of which can be intermittently shut off by a valve from passage of exhaust gas. A valve is known in this connection which is constituted outward of the housing as a flap valve in a pipe leading out of the related opening of the housing and pivotable perpendicularly of the pipe axis. The opening through which the flow of exhaust gas is prevented is situated within the muffler housing, on an end of this pipe projecting into the interior of the housing. The intermittent closing of, for example, one of two openings leading out of a muffler housing takes place in practice for the improvement of the noise damping which can be attained in the muffler housing with respect to the different quantitative flows of exhaust gas according to the engine operation. Thus, for example, a motor vehicle muffler with two outlet pipes attains a marked acoustic improvement in the low frequency noise region by the closing of one of these two pipes.

### SUMMARY OF THE INVENTION

The invention has as its object to provide a valve of the category concerned, with a simple and functionally reliable construction.

This object is attained by the embodiment of a valve of the category concerned wherein one of the housing openings can be closed with a closure element situated within the housing and displaceably mounted on the housing, when the one housing opening is closed, the closure element sealingly abuts on an edge of the one housing opening to be closed.

The invention is based on the general concept of embodying a valve of the category concerned in a simple manner, in that the movable closure element of a valve is a closure element which is mounted to be displaceable perpendicularly of the plane of the opening to be closed and which can be pushed against the opening to close it.

The displacement can take place by means of a servomotor or positioning motor, for example mounted on the outside of the muffler housing. The valve closure element can then be connected to the servomotor or positioning motor by means of a rod-shaped element.

In an economic production of a muffler housing with a valve of the category concerned, production tolerances as a rule arise which prevent a close seating of the closure element on the opening in the closed state of the valve, when there is a rigid fastening of the closure element to a positioning element going out from the servomotor or positioning motor. These production tolerances cannot, in most cases, be compensated for by elastic sealing means on the contact surfaces between the closure element and the opening to be closed. This particularly depends on the fact that such elastic sealing materials are not available for the high temperatures present in the exhaust gas passing through a muffler.

Tolerance-compensating elastic regions are provided in a coupling between the closure element and the positioning motor, and provide an embodiment with which reliable closure conditions of the valve are attainable even when there are relatively large production irregularities. This is attained by means of the tolerance-compensating elastic regions inserted as the adjusting element of the servomotor or positioning motor in the coupling to the closure element.

These tolerance-compensating regions can consist of elastically resilient, i.e., deformable, metal mesh or metal mesh fabric. Such metal mesh fabrics can per se durably withstand the high exhaust gas temperatures.

The metal mesh fabrics can be embodied practically impermeable to flow, which is important when they are situated in valve regions through which exhaust gases could flow when the valve is closed.

### BRIEF DESCRIPTION OF THE DRAWINGS

Embodiment examples of the invention are shown in the drawing.

FIG. 1 shows a schematic diagram of a muffler housing of an exhaust gas device with two exhaust gas outlet openings.

FIGS. 2 and 3 show alternative constitutions of the valve region denoted by II, III in FIG. 1.

### DETAILED DESCRIPTION OF THE INVENTION

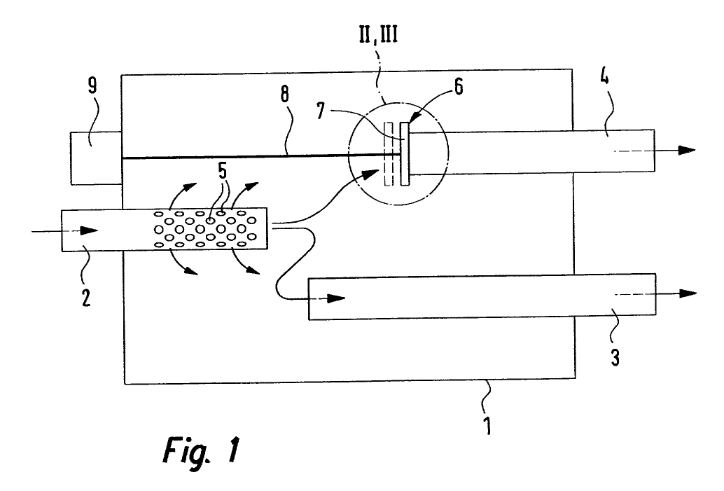

In the muffler housing 1 according to FIG. 1, an exhaust gas inlet and two exhaust gas outlets are provided, and are in fact respective pipes projecting into the interior of the muffler housing 1 and leading out of the housing, namely an inlet pipe 2 and also outlet pipes 3 and 4.

The exhaust gas flows via the inlet pipe 2 into the housing interior through perforations 5 provided in the portion of the inlet pipe 2 situated in the interior of the housing 1.

Of the outlet pipes, the outlet pipe 4 can be closed by a valve 6.

This valve 6 consists of the end opening, situated in the interior of the muffler housing 1, of the outlet pipe 4, as a valve seating, and a closure plate 7, which is displaceable along the pipe axis and thus perpendicularly of the opening of the pipe 4. The closure plate 7 of the valve 6 is connected via a connecting rod 8 to a servomotor or positioning motor 9 which is installed on the outside of the muffler housing.

The opening of the outlet pipe 4 can be opened and closed in a simple manner by displacement of the closure plate 7 by means of the servomotor or positioning motor 9. In the drawing, the valve 6 is shown in the closed state by full lines and in the opened state by dashed lines. The inflow and discharge of exhaust gas through the muffler housing are indicated by flow arrows.

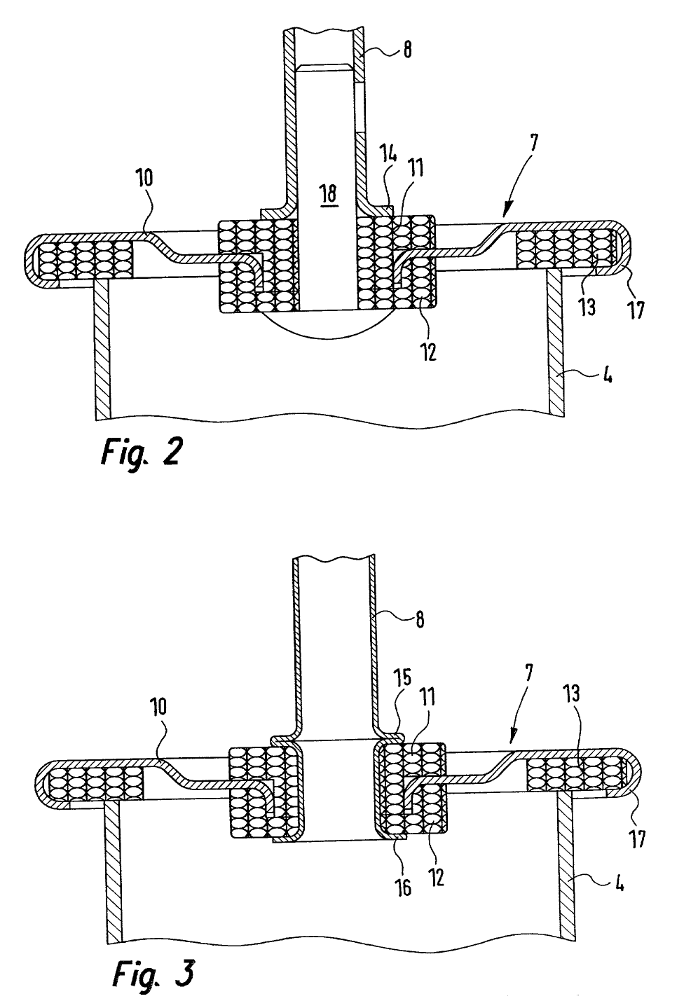

Special constitutions of the closure plate 7 and of its fastening to the connecting rod 8 are shown in FIGS. 2 and 3.

In the embodiment according to FIG. 2, an annular disk 10, for example of metal, is provided in the radially outer region of the closure plate 7. This annular disk 10 is connected by means of a doubled metal mesh fabric packing to the connecting rod 8 leading to the servomotor.

These metal mesh fabric packings 11 and 12 axially enclose the inner edge of the annular disk 10 between them. With a tubular constitution of the connecting rod 8, the fastening of the two metal mesh fabric packings 11 and 12 which axially enclose the annular disk 10 between them takes place by means of a rivet 18 pressed into the tubular cavity of the connecting rod 8 and with its head supported on one of the metal mesh fabric packings 11, 12, the metal mesh fabric packing 11 remote from the rivet head being pressed against an annular flange 14 provided on the connecting rod 8.

A metal mesh fabric sealing ring 13 is provided at the outer edge of the annular disk 10, in the region contacting the exhaust gas outlet pipe 4 at the end. Instead of the metal mesh fabric material, any other elastically resilient, sufficiently temperature-resistant sealing material can of course be used in the sealing ring 13. The same holds in principle for the metal mesh fabric packings 11, 12, as long as the material concerned is elastically resilient and sufficiently temperature-resistant with respect to its use in the muffler of an exhaust gas device. The sealing ring 13 can be fixed by a fold 17 rolled onto the annular disk 10.

The embodiment according to FIG. 3 differs from that according to FIG. 2 solely in the manner of clamping the metal mesh fabric packings 11 and 12 to the connecting rod 8. The clamping according to FIG. 3 takes place by means of flanges 15 and 16 formed, particularly rolled, on the tubular connecting rod 8. The flange 16 thus replaces the rivet head and the flange 15 replaces the annular flange 14 of the embodiment according to FIG. 2.

With the metal mesh fabric inserts 11, 12 and 13, angular misalignments of the closure plate 7 with respect to the opening edge of the outlet pipe 4 arising during manufacture can be compensated for to the extent of about 3 to 4 degrees of angle without further measures. In the case of a possible incomplete flow-tightness of the metal mesh fabric inserts 11, 12, 13, it can happen that very small amounts of exhaust gas, not functionally troublesome, pass through these knitted fabric regions. Such leakage exhaust gas streams when the valve is closed can be suppressed practically completely by an impregnation with, for example, graphite.

1. A valve in an exhaust gas muffler device of a motor vehicle with housing openings conducting exhaust gas and connecting the interior of a housing of the muffler device to outward of said housing, wherein:
one of said housing openings is closed by a closure element situated within said housing and displaceably mounted on said housing,
when said one housing opening is closed, said closure element sealingly abuts on an edge of said one housing opening,
a displacement axis of said closure element runs perpendicularly with respect to a plane of said one housing opening, and
said closure element is coupled by a coupling device to a positioning motor.

2. The valve according to claim 1, wherein at least one tolerance-compensating elastic region is provided in a coupling between said closure element and said positioning motor.

3. The valve according to claim 2, wherein an additional tolerance-compensating elastic region comprising elastically resilient material is provided for contact regions of said closure element and said edge of said one housing opening that mutually abut when the valve is closed.

4. The valve according to claim 1, wherein said coupling device comprises a rod-shaped element that extends from said positioning motor via an elastic connecting element.

5. The valve according to claim 4, wherein said elastic connecting element comprises metal mesh.

6. The valve according to claim 3, wherein said at least one tolerance-compensating elastic region comprises metal mesh.

7. The valve according to claim 2, wherein said at least one tolerance-compensating elastic region is fixed to an end of a rod-shaped element remote from said positioning motor by a rivet pressed into said rod-shaped element.

8. The valve according to claim 1, wherein tolerance-compensating elastic regions provide elastic connection between said closure element and a rod-shaped connecting element and are clamped fast in annular flanges formed on an end of said rod-shaped connecting element and situated remote from said positioning motor.

9. The valve according to claim 3, wherein said additional tolerance-compensating elastic region comprising elastically resilient material is provided radially outward on said closure element and held by a fold formed on a metallic region of said closure element.
